(19) United States
(12) Patent Application Publication
(10) Pub. No.: US 2016/0274878 A1
(43) Pub. Date: Sep. 22, 2016

(54) METHODS AND SYSTEMS FOR REMOVING PLT STUBS FROM DYNAMICALLY LINKED BINARIES

(71) Applicant: GOOGLE INC., Mountain View, CA (US)

(72) Inventors: Sriraman TALLAM, Mountain View, CA (US); Xinliang David LI, Mountain View, CA (US)

(73) Assignee: GOOGLE INC., Mountain View, CA (US)

(21) Appl. No.: 14/663,032

(22) Filed: Mar. 19, 2015

(51) Int. Cl. G06F 9/45; G06F 9/445

(52) U.S. Cl. CPC G06F 8/443; G06F 8/54

(57) ABSTRACT

Provided are methods and systems for removing Procedure Linkage Table (PLT) stubs from dynamically linked binaries. The methods and systems are designed to replace a call to an external function such that a global offset table entry is created for the function that will contain the address of the function and will be early bound. The call-site for the external function then performs one indirect call to the function using the global offset table entry containing the address of the external function.

### BACKGROUND

It is often the case that many C/C++ executables are dynamically linked. That is, certain library functions are built as shared objects and not linked into the executable. Further, the default symbol binding on these binaries is “lazy binding.” This means the dynamic linker only resolves addresses of functions unknown to the executable and defined in the shared object when the functions are called for the first time. This saves start-up time as the linker does not have to resolve every function at the beginning. This is done using the mechanism of PLT (Procedure Linkage Table).

Early symbol binding is often used when building secure binaries, which means the dynamic linker must resolve every referenced external function in shared objects at start-up. Although this makes calls through PLT unnecessary, the state-of-the-art is such that PLT is still being used with early symbol binding, even though it is known than PLT stubs can introduce pressure on the instruction cache (icache).

### SUMMARY

This Summary introduces a selection of concepts in a simplified form in order to provide a basic understanding of some aspects of the present disclosure. This Summary is not an extensive overview of the disclosure, and is not intended to identify key or critical elements of the disclosure or to delineate the scope of the disclosure. This Summary merely presents some of the concepts of the disclosure as a prelude to the Detailed Description provided below.

The present disclosure generally relates to methods and systems for compiling source code. More specifically, aspects of the present disclosure relate to optimizing source code compilation by removing PLT stubs from dynamically linked binaries.

One embodiment of the present disclosure relates to a computer-implemented method comprising: determining that an external function is defined in a shared object dynamically linked to an executable; creating a global offset table entry for the external function, wherein the global offset table entry contains an address of the external function; and indirectly calling the external function using the global offset table entry containing the address of the external function.

In another embodiment, the method further comprises replacing the indirect call to the external function with a direct call to the external function using a relocation type.

In another embodiment, the method further comprises creating a relocation type for calls to external functions, and modifying a compiler to call external functions indirectly with an instruction based on the created relocation type.

In another embodiment, the method further comprises determining that a function is defined in the executable, and replacing the indirect call instruction with a direct call to the function using the relocation type.

In yet another embodiment, the method further comprises: rewriting a binary to identify indirect calls to functions; determining that a function is a non-external function; and rewriting an indirect call to the function with a direct call to the function.

In still another embodiment, the method further comprises: generating a list, where the list includes one or more external functions and one or more non-external functions; sending the list to a compiler; generating an indirect call for each of the one or more external functions included in the list; and generating a direct call for each of the one or more non-external functions included in the list.

Another embodiment of the present disclosure relates to a system comprising at least one processor and a non-transitory computer-readable medium coupled to the at least one processor having instructions stored thereon that, when executed by the at least one processor, cause the at least one processor to: determine that an external function is defined in a shared object dynamically linked to an executable; create a global offset table entry for the external function, wherein the global offset table entry contains an address of the external function; and indirectly call the external function using the global offset table entry containing the address of the external function.

In another embodiment, the at least one processor of the system is further caused to replace the indirect call to the external function with a direct call to the external function using a relocation type.

In another embodiment, the at least one processor of the system is further caused to create a relocation type for calls to external functions, and modify a compiler to call external functions indirectly with an instruction based on the created relocation type.

In another embodiment, the at least one processor of the system is further caused to determine that a function is defined in the executable, and replace the indirect call instruction with a direct call to the function using the relocation type.

In yet another embodiment, the at least one processor of the system is further caused to: rewrite a binary to identify indirect calls to functions; determine that a function is a non-external function; and rewrite an indirect call to the function with a direct call to the function.

In still another embodiment, the at least one processor of the system is further caused to: generate a list, where the list includes one or more external functions and one or more non-external functions; send the list to a compiler; generate an indirect call for each of the one or more external functions included in the list; and generate a direct call for each of the one or more non-external functions included in the list.

Embodiments of some or all of the processor and memory systems disclosed herein may also be configured to perform some or all of the method embodiments disclosed above. Embodiments of some or all of the methods disclosed above may also be represented as instructions embodied on transitory or non-transitory processor-readable storage media such as optical or magnetic memory or represented as a propagated signal provided to a processor or data processing device via a communication network such as an Internet or telephone connection.

Further scope of applicability of the methods and systems of the present disclosure will become apparent from the Detailed Description given below. However, it should be understood that the Detailed Description and specific examples, while indicating embodiments of the methods and systems, are given by way of illustration only, since various changes and modifications within the spirit and scope of the concepts disclosed herein will become apparent to those skilled in the art from this Detailed Description.

### BRIEF DESCRIPTION OF DRAWINGS

These and other objects, features, and characteristics of the present disclosure will become more apparent to those skilled in the art from a study of the following Detailed Description in conjunction with the appended claims and drawings, all of which form a part of this specification. In the drawings:

FIG. 1 is a block diagram illustrating an example system and surrounding environment in which one or more embodiments described herein may be implemented.

FIG. 2 is a flowchart illustrating an example method for using the global offset table to call external functions without a PLT according to one or more embodiments described herein.

FIG. 3 is a flowchart illustrating an example method for creating a new relocation type to convert indirect calls to direct calls according to one or more embodiments described herein.

FIG. 4 is a flowchart illustrating an example method for post-processing a binary and rewriting an indirect call to a direct call according to one or more embodiments described herein.

FIG. 5 is a flowchart illustrating an example method for generating indirect calls only for truly external functions based on a list of external functions provided to a compiler according to one or more embodiments described herein.

FIG. 6 is a block diagram illustrating an example computing device arranged for removing PLT stubs from dynamically linked binaries according to one or more embodiments described herein.

The headings provided herein are for convenience only and do not necessarily affect the scope or meaning of what is claimed in the present disclosure.

In the drawings, the same reference numerals and any acronyms identify elements or acts with the same or similar structure or functionality for ease of understanding and convenience. The drawings will be described in detail in the course of the following Detailed Description.

### DETAILED DESCRIPTION

Various examples and embodiments of the methods and systems of the present disclosure will now be described. The following description provides specific details for a thorough understanding and enabling description of these examples. One skilled in the relevant art will understand, however, that one or more embodiments described herein may be practiced without many of these details. Likewise, one skilled in the relevant art will also understand that one or more embodiments of the present disclosure can include other features not described in detail herein. Additionally, some well-known structures or functions may not be shown or described in detail below, so as to avoid unnecessarily obscuring the relevant description.

Embodiments of the present disclosure relate to methods and systems for removing Procedure Linkage Table (PLT) stubs from dynamically linked binaries. For example, in accordance with at least one embodiment of the present disclosure, the methods and systems are designed for removing PLT stubs from dynamically linked binaries in the x86_64 architecture. As will be described in greater detail herein, the methods and systems of the present disclosure are designed to improve performance by, for example, reducing icache and itlb (translation lookaside buffer) pressure.

The following example is provided to aid in understanding what the PLT does. The example looks at the following program in file exec.cc:

extern int foo ( ); // Truly external library function, defined in a shared
library.
int main( ) {
return foo( );
}

The executable, a.out for the x86_64 architecture, may be built with this file and it may be assumed for purposes of the present example that function “foo” is defined in a shared object libfoo.so that is linked dynamically to this executable. Looking at the disassembly of a.out to observe the contents of main:

```
0000000000400766 <main>:
  ....
  40076a:  e8 71 fe ff ff callq  4005e0 <_Z3foov@plt>
```

The call to function foo in main is actually a call to a PLT stub, and the PLT stub for function foo looks like this:

```
00000000004005e0 <_Z3foov@plt>:
  4005e0:  jmpq *0x15d2(%rip)  # 401bb8
  <_GLOBAL_OFFSET_TABLE_+0x28>
  4005e6:  pushq $0x2
  4005eb:  jmpq  4005b0 <_init+0x28>
```

The PLT stub jumps to the contents of the GOT (global offset table) at entry 0x401bb8. This location will contain the actual address of function foo, which will be filled in by the dynamic linker at run-time. However, this may only be done on demand after the first call. The GOT entry 0x401bb8 may be set-up so that it contains the address 0x4005e6 to start with.

Thus, the first jump to this address from the PLT stub merely jumps to the next instruction. The instructions at 0x4005e6 and 0x4005eb are set-up to invoke the dynamic linker which replaces the GOT entry at location 0x401bb8 with the actual address of foo. The second call to PLT stub of foo can then directly jump to the function foo.

The mechanism described above is called lazy binding as the symbol foo was bound to the executable lazily. In early binding, the GOT entry at 0x401bb8 is patched at startup to contain the address of foo.

It is important to note that even with early binding, the function main calls the PLT stub of foo, which then jumps to the entry-point of the actual function body of foo. This poses a performance bottleneck, especially with regards to icache behavior, as the PLT stub of foo is not always placed adjacent to call-sites of foo. With early binding, the PLT stub of foo only has one relevant instruction, which is the first jump. Therefore, in accordance with one or more embodiments described herein, the methods and systems of the present disclosure are designed to replace every call-site of foo with this one instruction, thereby improving the resulting icache and itlb pressure.

Using the GOT to Call External Functions without a PLT

Referring back to the example described above, by looking at the assembly of function main as output by the GCC compiler, it can be seen that the call to function foo is just one instruction:

call _Z3foov

Under existing approaches, the linker replaces this call with the call to the PLT stub instead, since the definition of function foo is not local to the executable and is defined in a shared object libfoo.so, linked dynamically.

However, in accordance with one or more embodiments described herein, by configuring (e.g., teaching) the compiler to replace the call to function foo with the following, the need for a PLT stub may be avoided:

call *_Z3foov@GOTPCREL

Replacing the call to function foo in the manner described above creates a GOT entry for function foo that will contain the address of function foo and will be early bound. The call-site of foo then does one indirect call to foo. This technique, in effect, inlines the relevant PLT instruction at the call-site. Replacing the instruction in the example described above with the new instruction and looking at the final contents of function main in executable a.out:

0000000000400746 <main>:
...
40074a: ff 15 20 14 00 00 callq *0x1420(%rip)
#401b70 <_DYNAMIC+0x1e8>
...

Function main indirectly calls function foo using the contents at location 0x401b70, which is actually a GOT entry containing the address of foo.

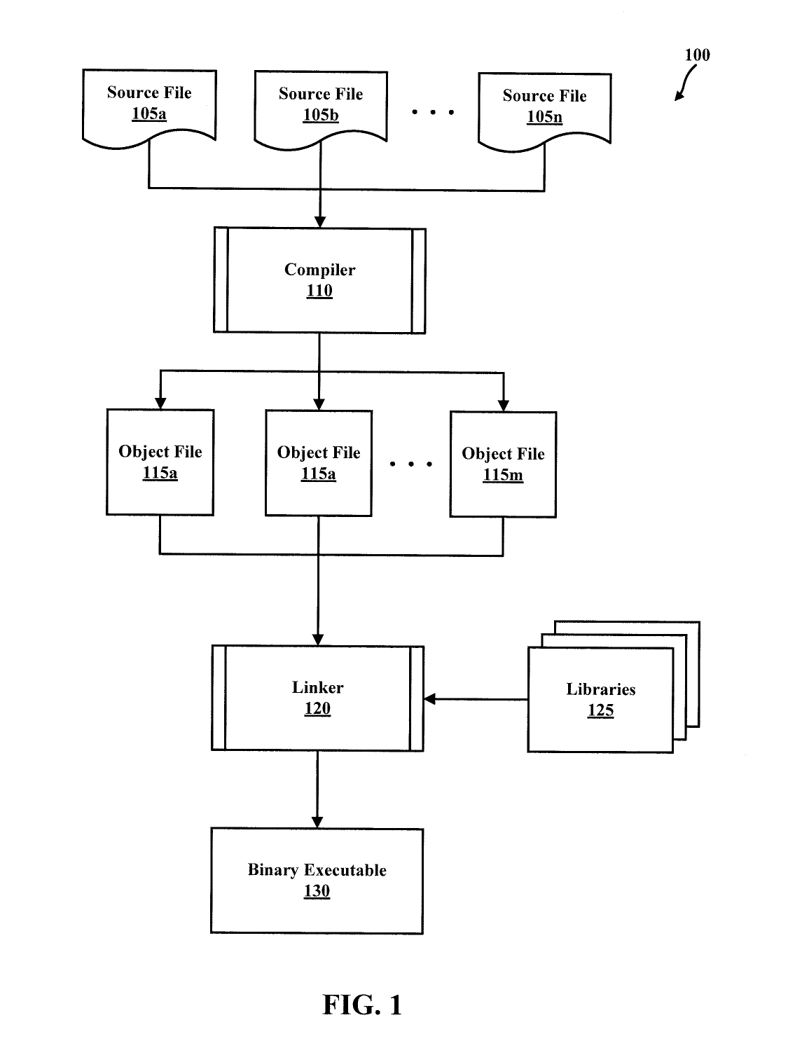

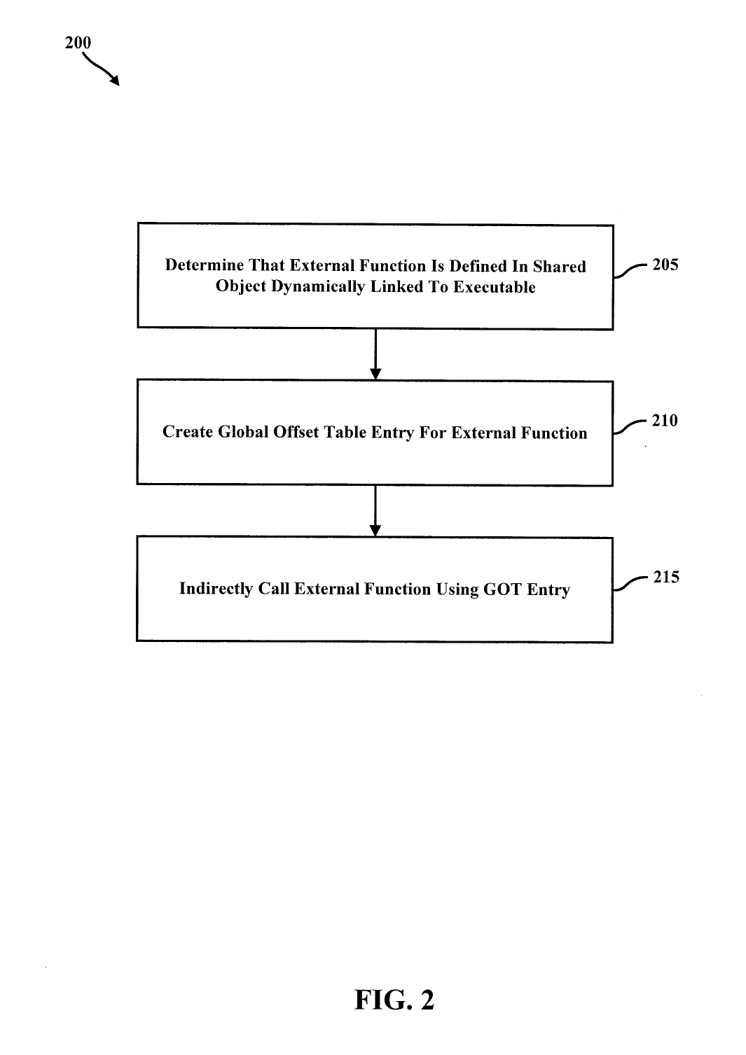

FIG. 2 illustrates an example process for using the GOT to call external functions without a PLT. In accordance with one or more embodiments described herein, the example process 200 may be performed by a system similar to system 100 described above and illustrated in FIG. 1.

At block 205, a determination may be made that an external function is defined in a shared object dynamically linked to the executable.

At block 210, a GOT entry may be created for the external function, where the created entry contains the address of the external function. In accordance with at least one embodiment, the GOT entry created at block 210 is early bound always.

At block 215, the compiler (e.g., compiler 110 in the example system 100 shown in FIG. 1) may indirectly call the external function using the GOT entry created at block 210.

In accordance with one or more embodiments of the present disclosure, the example process 200 for using the GOT to call external functions without a PLT may include one or more other operations (not shown) in addition to or instead of the example operations described above with respect to blocks 205-215.

Non-Truly External Functions

It should be noted that the example method for eliminating PLT stubs described above comes with a caveat. For example, consider modifying the above program to link foo into the executable itself by defining it in another file foo_def.cc. Now, foo is not a truly external function and does not need a PLT or an indirect jump to be called. However, the compiler has committed to do it indirectly and the linker cannot revert this. Note that in the original case, when the linker sees that foo is defined in the executable, the linker does not replace the call to foo to call a PLT stub. It just calls foo directly.

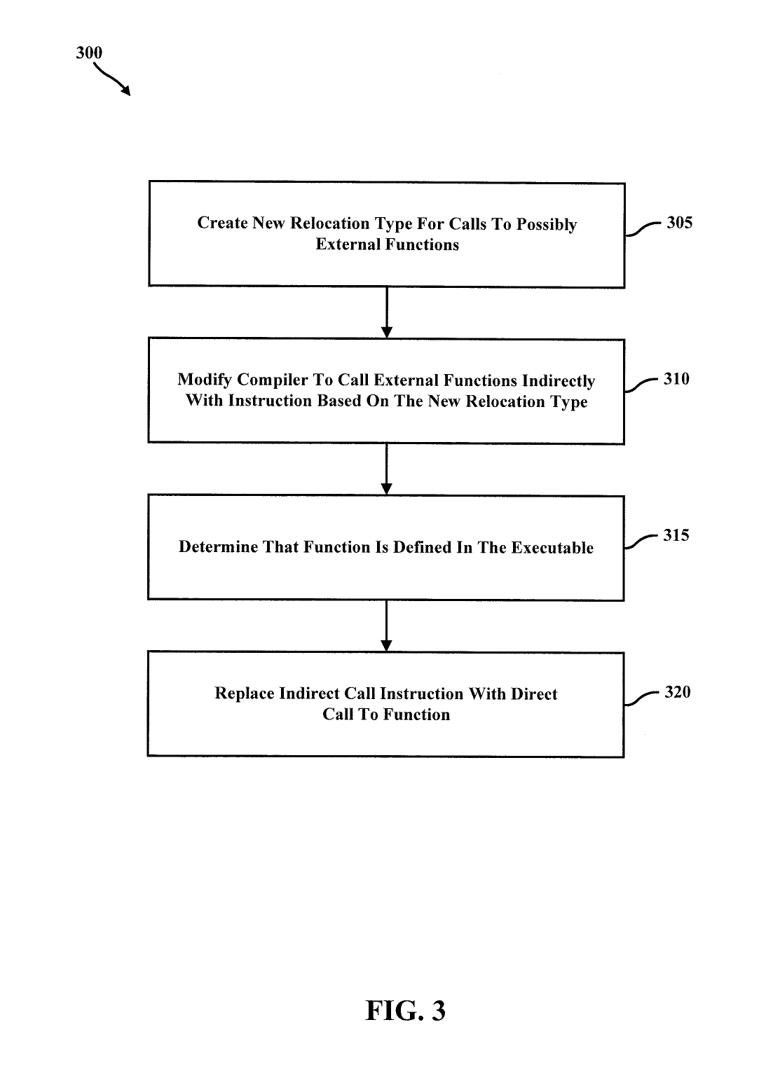

Accordingly, the present disclosure provides methods and systems for addressing this problem of non-truly external functions, example embodiments of which are described in greater detail below with respect to FIGS. 3-5. In accordance with one or more embodiments of the present disclosure, one or more of the example processes described below and illustrated in FIGS. 3-5 may be implemented using a system that includes at least a compiler and/or linker (e.g., compiler 110 and/or linker 120 in the example system 100 shown in FIG. 1).

1. New Relocation Type to Convert Indirect Calls to Direct Calls

In accordance with at least one embodiment of the present disclosure, the difficulties that arise with non-truly external functions may be resolved by creating a new relocation type for calls to possibly external functions. FIG. 3 illustrates an example process 300 for creating and using such a new relocation type. In accordance with at least one embodiment, a new relocation type called, for example, MAY_GOTPCREL, may be created at block 305. At block 310, the compiler may then be modified to call external functions indirectly with the instruction:

callq *_Z3foov@MAY_GOTPCREL(% rip)

One of the reasons for creating this new relocation type is to allow the linker to replace the entire instruction. Accordingly, the linker may do the following for each of these two example scenarios:

(i) If the linker finds that the definition of function foo is indeed from a shared object, then the linker may proceed in a manner similar to blocks 205-215 in the example process 200 described above and illustrated in FIG. 2. For example, the linker may keep the indirect call and replace the operand of the indirect call with the address of the GOT entry for function foo.

(ii) On the other hand, the linker may determine at block 315 that function foo is defined in the executable itself, and then at block 320 the linker may replace the whole indirect call instruction with a direct call to function foo that may look like, for example, the following:

nop #1-byte

call 0x40567a # (actual address of foo).

The second case (ii) described above is possible because a direct call instruction's length is 5 bytes (1 for opcode and 4 for operand), whereas an indirect call instruction is 6 bytes (2 for opcode and 4 for operand). However, when the indirect call is replaced with a direct call there is a 1 byte hole which can be replaced with the opcode for a nop instruction. This has, in-effect, achieved the best of both worlds.

2. Post Process the Binary and Rewrite the Indirect Calls to Direct Calls

The example process for creating a new relocation type for calls to possibly external functions to convert indirect calls to direct calls, as described above and illustrated in FIG. 3, may require changes to the x86_64 architecture. For example, one or more changes to the architecture may be needed to create a new relocation type and appropriate changes may also need to be made to the linker in order to process the new relocation type.

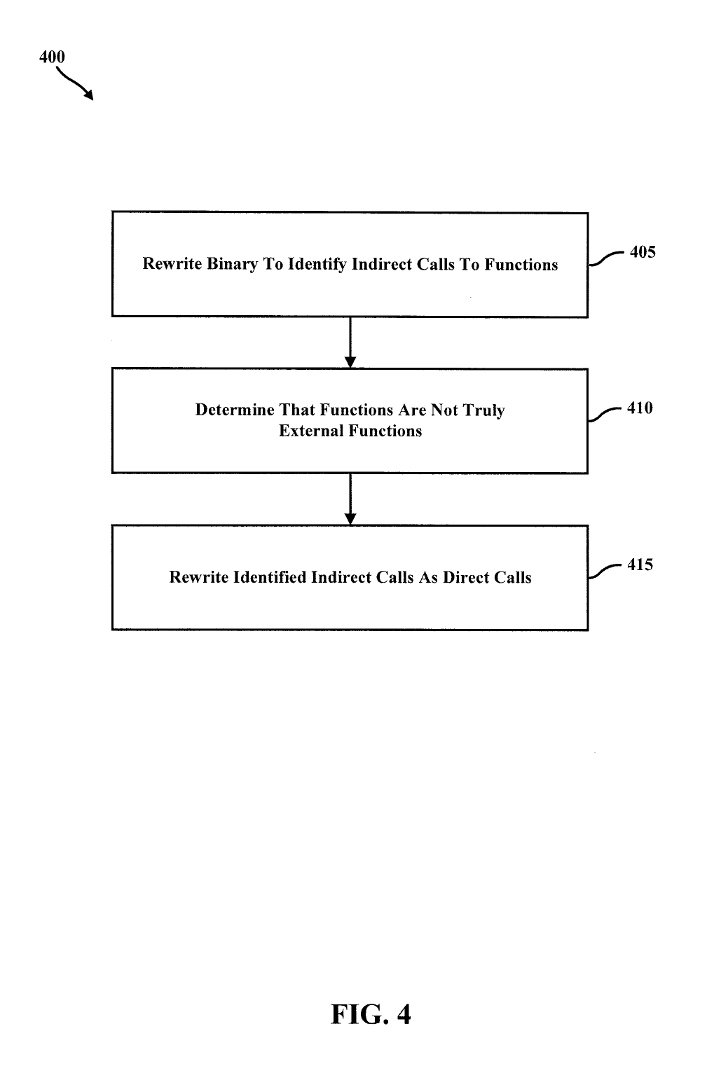

Therefore, in accordance with one or more other embodiments of the present disclosure, the problems that may arise with non-truly external functions may be resolved by the example process 400 shown in FIG. 4, which may include writing (e.g., creating, generating, etc.) a post-processing binary rewriting tool that rewrites the binary to find (e.g., identify, determine, etc.) indirect calls to functions that are not truly external (blocks 405 and 410), and then rewriting any such indirect calls with direct calls (block 415). Writing such a post-processing binary rewriting tool is a straightforward process and avoids the need to make any changes to the architecture. However, it should be noted that with the example process 400 described above and illustrated in FIG. 4, the binary incurs an additional step, which may involve changes to the corresponding build mechanisms.

It should be understood that in the example process 300 (described above and illustrated in FIG. 3), the linker is in effect doing what the post-processing binary rewriting tool would do in the example process 400 (described above and illustrated in FIG. 4), and the linker uses the new relocation type in order to do that.

3. Pass a List of Truly External Functions to the Compiler

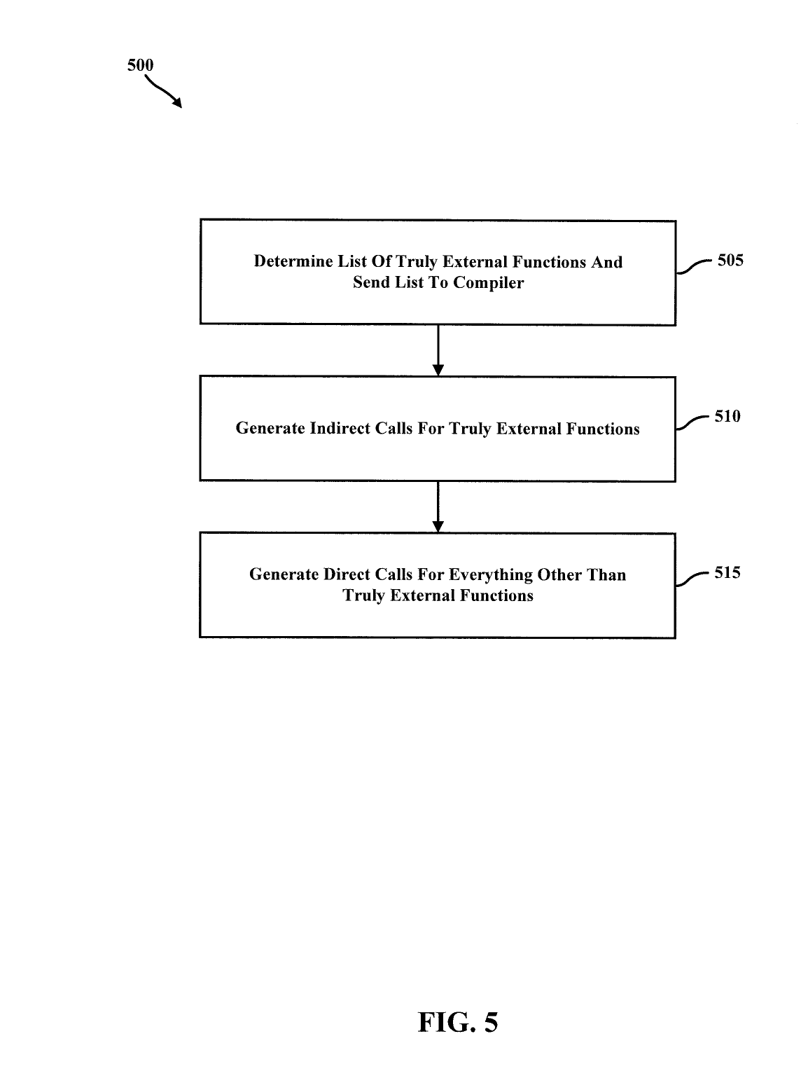

In accordance with one or more other embodiments of the present disclosure, the issues that may arise with non-truly external functions may also be resolved by finding (e.g., generating, determining, obtaining, etc.) a list of functions that are truly external and passing this list to the compiler. FIG. 5 illustrates an example of such a process 500, where at block 505 a list of functions determined to be truly external may be sent to the compiler. The compiler may then generate indirect calls for the truly external functions at block 510, and may generate direct calls for everything else at block 515.

In accordance with at least one embodiment described herein, the example process 500 for sending a list of truly external functions to the compiler may be implemented, for example, with builds that use instrumented profile feedback to build the optimized binary. Instrumented feedback directed compilation is a two-step process. The first step builds an instrumented binary that is run to collect execution profiles. The second step builds the actual optimized binary using the profiles. However, the instrumented binary and the optimized binary share the same set of truly external functions. As such, the process can be automated by collecting the list of such functions during the instrumentation build and passing the list along to the optimized build.

Lazy Symbol Bound Binaries

In accordance with one or more embodiments of the present disclosure, the example methods for resolving the difficulties that may arise with non-truly external functions described above (e.g., example processes 300, 400, and 500 illustrated in FIGS. 3-5, respectively) may be applied to lazy symbol bound binaries. For example, one or more of processes 300, 400, and 500 may be applied to lazy bound binaries using either of the following example approaches.

Hybrid Approach

In scenarios involving binaries that are lazily bound, it may not be appropriate to eliminate PLT stubs as doing so could increase start-up time. However, experiments with search binaries have shown that certain PLT stubs are too “hot” (as further explained below) and cause significant icache pressure, affecting performance by approximately 1%. It should be understood that, for executable binaries that are lazily bound, all calls to functions that are external take place by calling the corresponding PLT stubs of the functions. When some of the functions are frequently called (e.g., “hot functions”), their corresponding PLT stubs are also frequently called and are therefore referred to as “hot” PLT stubs. The PLT stubs are located in a separate section in the executable and do not have any spatial locality with the call-sites of the function. Thus, if some external functions are “hot,” this can cause icache pressure.

The above idea can be selectively applied only to hot call sites of truly external functions to eliminate the PLT call. Only a small fraction of functions will then need to be early bound and the start-up time increase can be kept to a minimum.

Splitting the PLT Stub

As an alternative to the hybrid approach described above, a PLT stub may be split into two parts. Referring back to the example presented above, a PLT stub may look like the following:

```
00000000004005e0 <_Z3foov@plt>:
  4005e0: jmpq *0x15d2(%rip) # 401bb8
  <_GLOBAL_OFFSET_TABLE_+0x28>
  4005e6: pushq $0x2
  4005eb: jmpq 4005b0 <_init+0x28>
```

In accordance with at least one embodiment, the PLT stub may be split and the first instruction that jumps to the contents of the GOT entry may be deleted. As such, the split PLT stub may look like the following:

```
00000000004005e0 <_Z3foov@plt>:
  4005e6: pushq $0x2
  4005eb: jmpq  4005b0 <_init+0x28>
and the call-site may look like:
callq *0x15d2(%rip)  # 401bb8
<_GLOBAL_OFFSET_TABLE_+0x28>
```

Now, the GOT entry at address 0x401bb8 contains the address of the first instruction in the PLT, 0x4005e6. In effect, for the first call to function foo, the PLT is still called indirectly where the address fix-up happens using the dynamic linker. However, from the second call to function foo, the call becomes an indirect call without using the PLT. This achieves lazy binding and eliminates the PLT overhead.

In accordance with at least one embodiment, instead of splitting the original form of the PLT stub, as described above, the first instruction that jumps to the contents of the GOT entry can be ignored (as opposed to deleted following the split).

It should be noted that one or more embodiments of the present disclosure may include, or be implemented in conjunction with, an application programming interface (API) that allows users to retrieve the data collected by the methods and systems described herein. For example, a web service may provide a user with access (which may be immediate or instantaneous access) to the data collected from one or more compilers configured to perform the methods described herein. In accordance with one or more other embodiments, a user may utilize a tool (e.g., a web browser) that enables the user to view his or her source code together with links that interact with one or more servers on which the methods and systems described herein may be implemented.

It should also be understood that the data generated as a result of the methods and systems described herein may be provided to the user in a variety of ways. For example, in accordance with at least one embodiment, the data may be presented in a user interface screen accessible to the user, where the data may be highlighted in the user interface screen for easy identification and interpretation by the user. In accordance with one or more other embodiments, the data may be provided to the user by using a command line, by using a text space IDE, or by any of a number of other ways.

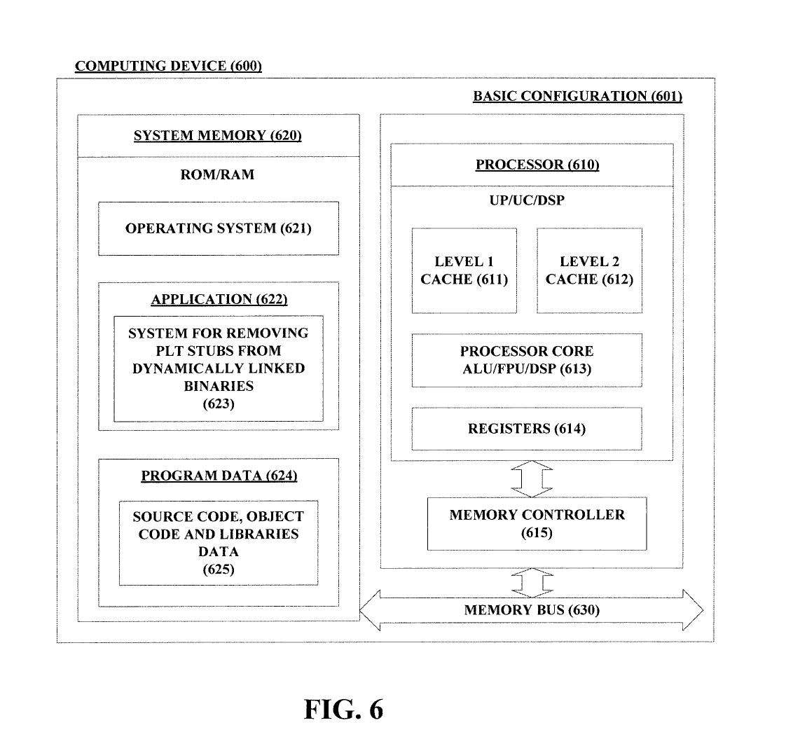

FIG. 6 is a high-level block diagram of an exemplary computer (600) that is arranged for removing PLT stubs from dynamically linked binaries, in accordance with one or more embodiments described herein. For example, in accordance with at least one embodiment, computer (600) may be configured to use the GOT to call external functions without a PLT. In accordance with one or more other embodiments, computer (600) may be further configured to create a new relocation type to convert indirect calls to direct calls; perform post-processing on a binary to rewrite an indirect call to a direct call; and/or generate indirect calls only for truly external functions based on a list of external functions provided to the computer (600). In a very basic configuration (601), the computing device (600) typically includes one or more processors (610) and system memory (620). A memory bus (630) can be used for communicating between the processor (610) and the system memory (620).

Depending on the desired configuration, the processor (610) can be of any type including but not limited to a microprocessor (μP), a microcontroller (μC), a digital signal processor (DSP), or any combination thereof. The processor (610) can include one more levels of caching, such as a level one cache (611) and a level two cache (612), a processor core (613), and registers (614). The processor core (613) can include an arithmetic logic unit (ALU), a floating point unit (FPU), a digital signal processing core (DSP Core), or any combination thereof. A memory controller (616) can also be used with the processor (610), or in some implementations the memory controller (615) can be an internal part of the processor (610).

Depending on the desired configuration, the system memory (620) can be of any type including but not limited to volatile memory (such as RAM), non-volatile memory (such as ROM, flash memory, etc.) or any combination thereof. System memory (620) typically includes an operating system (621), one or more applications (622), and program data (624). The application (622) may include a system for removing PLT stubs from dynamically linked binaries (623), which may be configured to use the GOT to call external functions without a PLT, according to one or more embodiments of the present disclosure. The system (623) may also be configured to create a new relocation type to convert indirect calls to direct calls; perform post-processing on a binary to rewrite an indirect call to a direct call; and/or generate indirect calls only for truly external functions based on a list of external functions, according to one or more embodiments.

Program Data (624) may include storing instructions that, when executed by the one or more processing devices, implement a system (623) and method for removing PLT stubs from dynamically linked binaries. Additionally, in accordance with at least one embodiment, program data (624) may include source code, object code, and libraries data (625), which may relate to data used by a compiler and linker (e.g., compiler 110 and linker 130 in the example system 100 shown in FIG. 1) to generate an executable. In accordance with at least some embodiments, the application (622) can be arranged to operate with program data (624) on an operating system (621).

The computing device (600) can have additional features or functionality, and additional interfaces to facilitate communications between the basic configuration (601) and any required devices and interfaces.

System memory (620) is an example of computer storage media. Computer storage media includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by computing device 600. Any such computer storage media can be part of the device (600).

The computing device (600) can be implemented as a portion of a small-form factor portable (or mobile) electronic device such as a cell phone, a smartphone, a personal data assistant (PDA), a personal media player device, a tablet computer (tablet), a wireless web-watch device, a personal headset device, an application-specific device, or a hybrid device that include any of the above functions. The computing device (600) can also be implemented as a personal computer including both laptop computer and non-laptop computer configurations.

The foregoing detailed description has set forth various embodiments of the devices and/or processes via the use of block diagrams, flowcharts, and/or examples. Insofar as such block diagrams, flowcharts, and/or examples contain one or more functions and/or operations, it will be understood by those within the art that each function and/or operation within such block diagrams, flowcharts, or examples can be implemented, individually and/or collectively, by a wide range of hardware, software, firmware, or virtually any combination thereof. In accordance with at least one embodiment, several portions of the subject matter described herein may be implemented via Application Specific Integrated Circuits (ASICs), Field Programmable Gate Arrays (FPGAs), digital signal processors (DSPs), or other integrated formats. However, those skilled in the art will recognize that some aspects of the embodiments disclosed herein, in whole or in part, can be equivalently implemented in integrated circuits, as one or more computer programs running on one or more computers, as one or more programs running on one or more processors, as firmware, or as virtually any combination thereof, and that designing the circuitry and/or writing the code for the software and or firmware would be well within the skill of one of skill in the art in light of this disclosure. In addition, those skilled in the art will appreciate that the mechanisms of the subject matter described herein are capable of being distributed as a program product in a variety of forms, and that an illustrative embodiment of the subject matter described herein applies regardless of the particular type of non-transitory signal bearing medium used to actually carry out the distribution. Examples of a non-transitory signal bearing medium include, but are not limited to, the following: a recordable type medium such as a floppy disk, a hard disk drive, a Compact Disc (CD), a Digital Video Disk (DVD), a digital tape, a computer memory, etc.; and a transmission type medium such as a digital and/or an analog communication medium (e.g., a fiber optic cable, a waveguide, a wired communications link, a wireless communication link, etc.)

With respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

It should also be noted that in situations in which the systems and methods described herein may collect personal information about users, or may make use of personal information, the users may be provided with an opportunity to control whether programs or features associated with the systems and/or methods collect user information (e.g., information about a user's preferences). In addition, certain data may be treated in one or more ways before it is stored or used, so that personally identifiable information is removed. For example, a user's identity may be treated so that no personally identifiable information can be determined for the user. Thus, the user may have control over how information is collected about the user and used by a server.

Thus, particular embodiments of the subject matter have been described. Other embodiments are within the scope of the following claims. In some cases, the actions recited in the claims can be performed in a different order and still achieve desirable results. In addition, the processes depicted in the accompanying figures do not necessarily require the particular order shown, or sequential order, to achieve desirable results. In certain implementations, multitasking and parallel processing may be advantageous.

1. A computer-implemented method comprising:
determining that a function is an external function based on the function being defined in a shared object dynamically linked to an executable;
creating a global offset table entry for the external function, wherein the global offset table entry contains an address of the external function;
indirectly calling the external function using the global offset table entry containing the address of the external function; and
in response to determining that the function is defined in the executable, replacing the indirect call to the function with a direct call to the function using a relocation type.

2. The method of claim 1, further comprising:
determining that the function is a non-external function; and
replacing the indirect call to the non-external function with a direct call to the non-external function using the relocation type.

3. The method of claim 1, further comprising:
creating a relocation type for calls to external functions; and
modifying a compiler to call external functions indirectly with an instruction based on the created relocation type.

4. The method of claim 1, further comprising:
using a binary rewriting tool to identify indirect calls to non-external functions; and
rewriting the identified indirect calls with direct calls to the non-external functions.

5. The method of claim 1, further comprising:
rewriting a binary to identify indirect calls to functions;
determining that one of the functions is a non-external function; and
rewriting an indirect call to the non-external function with a direct call to the non-external function.

6. The method of claim 5, wherein the binary is rewritten using a binary rewriting tool.

7. The method of claim 1, further comprising:
generating a list, wherein the list includes one or more external functions and one or more non-external functions;
sending the list to a compiler;
generating an indirect call for each of the one or more external functions included in the list; and
generating a direct call for each of the one or more non-external functions included in the list.

8. A system comprising:
at least one processor; and
a non-transitory computer-readable medium coupled to the at least one processor having instructions stored thereon that, when executed by the at least one processor, cause the at least one processor to:
determine that a function is an external function based on the function being defined in a shared object dynamically linked to an executable;
create a global offset table entry for the external function, wherein the global offset table entry contains an address of the external function;
indirectly call the external function using the global offset table entry containing the address of the external function; and
in response to determining that the function is defined in the executable, replace the indirect call to the function with a direct call to the function using a relocation type.

9. The system of claim 8, wherein the at least one processor is further caused to:
determine that the function is a non-external function; and
replace the indirect call to the non-external function with a direct call to the non-external function using the relocation type.

10. The system of claim 8, wherein the at least one processor is further caused to:
create a relocation type for calls to external functions; and
modify a compiler to call external functions indirectly with an instruction based on the created relocation type.

11. The system of claim 8, wherein the at least one processor is further caused to:
use a binary rewriting tool to identify indirect calls to non-external functions; and
rewrite the identified indirect calls with direct calls to the non-external functions.

12. The system of claim 8, wherein the at least one processor is further caused to:
rewrite a binary to identify indirect calls to functions;
determine that one of the functions is a non-external function; and
rewrite an indirect call to the non-external function with a direct call to the non-external function.

13. The system of claim 12, wherein the binary is rewritten using a binary rewriting tool.

14. The system of claim 8, wherein the at least one processor is further caused to:
generate a list, wherein the list includes one or more external functions and one or more non-external functions;
send the list to a compiler;
generate an indirect call for each of the one or more external functions included in the list; and
generate a direct call for each of the one or more non-external functions included in the list.

15. One or more non-transitory computer readable media storing computer-executable instructions that, when executed by one or more processors, cause the one or more processors to perform operations comprising:
determining that a function is an external function based on the function being defined in a shared object dynamically linked to an executable;
creating a global offset table entry for the external function, wherein the global offset table entry contains an address of the external function;
indirectly calling the external function using the global offset table entry containing the address of the external function; and
in response to determining that the function is defined in the executable, replacing the indirect call to the function with a direct call to the function using a relocation type.

16. The one or more non-transitory computer readable media of claim 15, wherein the computer-executable instructions, when executed by the one or more processors, cause the one or more processors to perform further operations comprising:
determining that the function is a non-external function; and
replacing the indirect call to the non-external function with a direct call to the non-external function using a relocation type.

17. The one or more non-transitory computer readable media of claim 15, wherein the computer-executable instructions, when executed by the one or more processors, cause the one or more processors to perform further operations comprising:
creating a relocation type for calls to external functions; and
modifying a compiler to call external functions indirectly with an instruction based on the created relocation type.

18. The one or more non-transitory computer readable media of claim 15, wherein the computer-executable instructions, when executed by the one or more processors, cause the one or more processors to perform further operations comprising:
using a binary rewriting tool to identify indirect calls to non-external functions; and
rewriting the identified indirect calls with direct calls to the non-external functions.

19. The one or more non-transitory computer readable media of claim 15, wherein the computer-executable instructions, when executed by the one or more processors, cause the one or more processors to perform further operations comprising:
rewriting a binary to identify indirect calls to functions;
determining that one of the functions is a non-external function; and
rewriting an indirect call to the non-external function with a direct call to the non-external function.

20. The one or more non-transitory computer readable media of claim 15, wherein the computer-executable instructions, when executed by the one or more processors, cause the one or more processors to perform further operations comprising:
generating a list, wherein the list includes one or more external functions and one or more non-external functions;
sending the list to a compiler;
generating an indirect call for each of the one or more external functions included in the list; and
generating a direct call for each of the one or more non-external functions included in the list.
